(19) United States
(12) Patent Application Publication
(10) Pub. No.: US 2013/0148461 A1
(43) Pub. Date: Jun. 13, 2013

(54) Apparatus And Methods For Controlling The Composition Of Fluids In A Fluid Stream

(71) Applicants: Guo-Zhong Li, Westborough, MA (US); Kurt Joudrey, Newton, MA (US); Ryszard Feldman, Framingham, MA (US); John Heden, Hollis, NH (US); Michael Jackson, Woonsocket, RI (US); John Angelosanto, North Attleboro, MA (US)

(72) Inventors: Guo-Zhong Li, Westborough, MA (US); Kurt Joudrey, Newton, MA (US); Ryszard Feldman, Framingham, MA (US); John Heden, Hollis, NH (US); Michael Jackson, Woonsocket, RI (US); John Angelosanto, North Attleboro, MA (US)

(73) Assignee: WATERS TECHNOLOGIES CORPORATION, Milford, MA (US)

(21) Appl. No.: 13/521,313

(22) PCT Filed: Jan. 10, 2011
(86) PCT No.: PCT/US11/20633

§ 371 Date: Aug. 30, 2012

Related U.S. Application Data
(60) Provisional application No. 61/293,872, filed on Jan. 11, 2010.

(51) Int. Cl. B01F 15/04

(52) U.S. Cl. CPC B01F 15/0404
USPC 366/152.2; 366/152.1

(57) ABSTRACT

Embodiments of the present invention are directed to a devices and methods for forming a desired miture of two or more fluids in a conduit. The devices and methods feature control means having error monitoring means and in response to an error event the control means organizes the packet-group of command signals to form at least one first error packet group. The error event occurs during the period of time in which the at least one error packet-group is received by a selectable value. The at least one error packet-group comprising an order or timing of first command signals and second commands signals to minimize deviation from the desired mixture in the flow of mixture-packets forming the desired mixture of two or more fluids in a conduit during the error event.

### RELATED APPLICATION

This application claims the benefit of U.S. Provisional Application Ser. No. 61/293,872, filed Jan. 11, 2010. The entirety of which the provisional application is incorporated by reference herein.

### STATEMENT REGARDING FEDERAL SPONSORSHIP

The present invention was made without Federal funds or support.

### FIELD OF THE INVENTION

Embodiments of the present invention are directed to an apparatus and methods for controlling the mixture composition of fluids in a fluid stream. Embodiments of the present invention address deviations in the mixture composition as two or more fluids are placed in a fluid flow at one pressure and brought to a second pressure by pumping. These errors are potentially due to mechanical events, compression events, adiabatic events, miscibility events, a change in mixture, and timing events.

### BACKGROUND OF THE INVENTION

This discussion will introduce certain terms and phrases for which the following definitions are provided for clarity and to facilitate an understanding of the invention.

As used herein, “chromatography” is a separation technique used to separate compositions from each other based on the affinity of each compound, in a mixture of compounds held in a solution, for or to a media through which the composition is moving in relation to. The media is normally held stationary and is sometimes referred to as the stationary phase. The media is normally a bed of particles or beads or a porous monolith. The solution moving through the media is often referred to as the mobile phase. The mobile phase can be a gas or a liquid or a gas held at a critical, or near critical, or super critical, pressure and temperature. As used herein, the term “fluid” refers to all gases and liquids, and critical, near critical and supercritical fluids.

Chromatographic separations can be performed in a single solution in which the composition of the solution does not change. These separations are referred to as isocratic separations. Often, it is desirable to change the composition of the solution during the separation. Separations in which the solutions are modified over time are referred to as gradient separations.

High performance liquid chromatography (HPLC), gas and critical, near critical and supercritical chromatography are performed in substantially closed systems under pressure. These techniques have broad applications, for example, which certainly is not intended to be an exhaustive list, these techniques are used for drug discovery, chemical analysis, human and veterinary diagnostics, forensics, manufacturing, pharmaceutical processes, and quality control.

It is desirable to have chromatographic processes that are highly reproducible, with few deviations from desired parameters set by the user.

### SUMMARY OF THE INVENTION

Embodiments of the present invention address deviations in mixing two or more fluids in a conduit from a desired mixture. As used herein, the term “conduit” is used broadly in the sense of a closed fluid system which may comprise tubing, pipes, capillaries, and ancillary apparatus, including, but not limited to, pumps, valves, detectors, and columns. This paper will use the term “error” to mean a deviation from the desired composition. Embodiments of the present invention have utility in chromatography in closed systems such as HPLC, gas or critical, near critical or supercritical chromatographic systems.

Embodiments of the present invention, directed to a device for forming a desired mixture of two or more fluids in a conduit, comprise at least one selectable valve in fluid communication with a source of a first fluid and a source of at least one second fluid. The selectable valve is in signal communication with control means to receive a plurality of first command signals and a plurality of second command signals. Each first command signal directs the selectable valve to produce a first fluid slice, and each second command signal directs the selectable valve to produce a second fluid slice. These first fluid slices and second fluid slices are combined in the conduit to create a flow of first fluid slices and second fluid slices. The device further comprises control means in signal communication with the selectable valve means. The control means, in response to a desired mixture order, issues a packet-group of first slice command signals and second slice command signals to the selectable valve to form a mixture-packet of one or more first fluid and second fluid slices. The mixture-packet is one or more first fluid and second fluid slices that correspond to the desired mixture. The control means has error monitoring means and in response to an error event the control means organizes the packet-group of command signals to form at least one first error packet group such that the error event occurs during the period of time in which the at least one error packet-group is received by the at least one selectable valve. The at least one error packet-group comprising an order or timing of first command signals and second command signals to minimize deviation from the desired mixture in the flow of mixture-packets forming the desired mixture of two or more fluids in a conduit during the error event.

The desired mixture, in a chromatographic process is the proportion of a first fluid to a second fluid; for example, the proportion of water to the proportion of acetonitrile in a solution, for example, 5% water and 95% acetonitrile. Of course, this proportion can be expressed in numerous ways. In gradient processes, the proportion changes over time.

A selectable valve is a valve plumbed to switch from one fluid source to another fluid source. In chromatographic processes, one type of selectable valve is known as a gradient proportioning valve or GPV. The term fluid slices refers to a volume of fluid discharged upon the selectable valve moving from a closed position to an open position and back to a closed position. The term slice is a way of visualizing a segment of fluid entering the conduit. A mixture-packet is the group of fluid slices in the conduit which are intended to form the desired mixture upon the slices mixing due to turbulence through wall effects and diffusion.

Control means is used to denote computers and computer systems, both internal to a larger assembly and in the nature of a server external to the larger system. The term signal communication is used in the sense of capable of sending or receiving data or commands, such as when wired or through wireless radio, infrared or optical communication systems. The term slice command signal refers to signals sent to the selectable valve to open and close to create a slice. The term packet group refers to the group of slice command signals which when acted upon by the selectable valve will form a fluid packet having the desired mixture.

One embodiment of the present invention features a device wherein the error packet-group has at least two or more consecutive fluid slices selected from one source. Another embodiment features at least two error packet-groups associated with a single error event to form a first error packet group having a last in series slice, and a second error packet having a first in series slice, wherein said first in series slice and said end of series slice are adjacent and selected from one source.

An error event is an event which causes a deviation from the desired mixture, for example, the movement of a group of packets from an area of low pressure to an area of alternating low and high pressure, or from an area of alternating low and high pressure to an area of high pressure in the conduit. These areas are defined in chromatographic instruments by certain common components. Low pressure areas commonly comprise the fluid circuit from the fluid source, through the selectable valve and up to a first high pressure valve. The area of alternating low and high pressure is normally from the valve up through the pump chamber under the influence of a reciprocating piston. The high pressure area is the area downstream from a second high pressure valve. The high pressure valves are commonly check valves of a passive or active type.

Another example of an error event is a mechanical event. For example, without limitation, one mechanical event is response time for a valve, either a high pressure valve or the selectable valve. Another example of a mechanical event is the expansion and contraction of one or more components of the conduit. Expansion and contraction is associated with pump chambers and pistons, adiabatic effects, compliance of materials such as seals, gaskets and diaphragms and valve operation. For example, check valves of the passive type may have seating and release delays due to fluid viscosity or mechanical stickiness of balls to the ball seating areas of the valve. Check valves of the active type may have seating and release issues like the passive valve and may also have components and parts which expand or contract the conduit or fluid circuit during operation, for example, diaphragms or valve stems which move during the operation of the valve.

One embodiment of the present invention features an error event of a mechanical type associated with expansion and contraction volume. The error packet group comprises consecutive slices of a fluid from a selected source in which the consecutive slices having a consecutive slice volume approximately equal to the expansion and contraction volume.

One embodiment of the present invention features a conduit means further comprising at least one downstream valve. The at least one downstream valve receives mixture packets from the selectable valve, and the downstream valve has two operable positions comprising an open position in which mixture packets flow through said conduit and a closed position in which said mixture packets do not flow. The downstream valve is preferably associated with a pump chamber forming the boundary of the alternating low and high pressure area and/or the high pressure area. Thus, the downstream valve is preferably a high pressure valve, such as a passive or active check valve. One embodiment of the present invention relates to an error event associated with the downstream valve as the downstream valve assumes one of the operable positions.

One embodiment features a downstream valve in signal communication with control means to receive one or more downstream valve command signals. The downstream valve upon receiving the downstream command signal assumes one of the operable positions. Preferably, the downstream valve command signal is recognized by error monitoring means as an error event.

One embodiment of the present invention further comprises a pump having at least one chamber defining an area of alternating high and low pressure, and a piston for assuming at least one piston first position wherein said chamber has a high pressure and at least one piston second position in which the chamber has a low pressure. The error event is associated with the pump assuming at least one of the piston positions. A further embodiment further comprises motor means mechanically linked to the piston to compel the piston to assume one of the piston positions. Preferably, the motor means is in signal communication with the control means and receives motor command signals to assume one of said piston positions. This motor command signal is, preferably, recognized by error monitoring means as an error event.

One embodiment of the present invention features control means that receives first directions for a first mixture and second directions for a second mixture. The first mixture has a first composition, of first fluid and second fluid, and the second mixture has a second composition, of first fluid and second fluid, which first fluid composition and second fluid composite are different, for example, without limitation during gradient chromatographic processes. The transition, directions for a first mixture to a second mixture, is recognized by error monitoring means as an error event. As used herein, the term “recognized” means identified in the computer code or sensor data by the error monitoring means. Error monitoring means is computer systems of the control means which compare data values or compare input codes with control values, calibration values, preprogrammed values and codes to determine if such fall within acceptable values and codes or outside.

Preferably, the control means commands the pump to assume one of the piston positions as the packet groups for the first mixture end and the packet groups for the second mixture begin.

One embodiment of the present device is directed to an error event associated with an error volume. At least one error packet group has consecutive slices selected from a source having a slice volume approximately equal to the error volume.

A further embodiment of the present invention is directed to a method of forming a desired mixture in a conduit. The method comprises the step of providing a conduit having at least one selectable valve in fluid communication with a source of a first fluid and a source of at least one second fluid. The selectable valve is in signal communication with control means to receive a plurality of first command signals and a plurality of second command signals. Each first command signal produces a first fluid slice, and each second command signal produces a second fluid slice, to create a flow of first fluid slices and second fluid slices in the conduit. The method further comprises the step of providing control means in signal communication with the selectable valve. The control means, in response to a desired mixture order, issues a packet-group of first command signals and second command signals to the selectable valve to form a mixture-packet of one or more first fluid and second fluid slices. The mixture-packet of one or more first fluid and said second fluid slices corresponds to the desired mixture. The control means has error monitoring means and in response to an error event the control means organizes the packet-group of command signals to form at least one first error packet group such that error event occurs during the period of time in which the at least one error packet-group is received by the at least one selectable valve. The at least one error packet-group comprising an order of first command signals and second command signals to minimize deviation from said desired mixture in the flow of mixture-packets forming the desired mixture of two or more fluids in a conduit during the error event. The method further comprises the step of providing a desired mixture order to the control means and operating the control means to produce the desired mixture in the conduit.

As used herein, the term “desired mixture order” refers to the directions placed by the user or implied from the directions placed by a user; for example, directions to run a gradient. Further embodiments of the method of the present invention have features that are analogous to those previously described with respect to the device.

A further embodiment of the present invention is directed to a computer storage device for providing operating instructions to control means in signal communication with a fluid conveying device for forming a desired mixture of two or more fluids in a conduit. The fluid conveying device has at least one selectable valve in fluid communication with a source of a first fluid and a source of at least one second fluid. The selectable valve is in signal communication with control means to receive a plurality of first command signals and a plurality of second command signals. Each first command signal is to produce a first fluid slice, and each second command signal is to produce a second fluid slice, to create a flow of first fluid slices and second fluid slices in the conduit. The fluid conveying device further comprises control means having error monitoring means. The control means is in signal communication with the selectable valve. The error monitoring means detects an error event or detects a potential error event.

The operating instructions instruct control means, in response to a desired mixture order, to issue a packet-group of first command signals and second command signals to the selectable valve to form a mixture-packet of one or more first fluid and second fluid slices in which the mixture-packet of one or more first fluid and said second slices corresponds to the desired mixture. The operating instructions direct control means, in response to an error event from error monitoring means, organizes the packet-group of command signals to form at least one first error packet group such that error event occurs during the period of time in which the at least one error packet-group is received by the at least one selectable valve. The at least one error packet-group comprises an order of first command signals and second command signals to minimize deviation from the desired mixture in the flow of mixture-packets forming the desired mixture of two or more fluids in a conduit during the error event.

As used herein, the term “computer storage device” refers to memory for storing computer programs such as, by way of example, without limitation, computer storage disks, tapes, flash drives, hard drives, CDs, DVDs, memory sticks, and chips, whether integral to the computer or external. As used herein, the term “operating instructions” comprise computer code which instructs control means to receive or send command signals or status signals such as an error event.

Other objects, features and advantages of the present invention will be apparent upon viewing the drawings which are described in summary form below and reading the Detailed Description that follows.

### BRIEF SUMMARY OF THE DRAWINGS

FIG. 1 depicts in schematic form a chromatographic instrument embodying features of the present invention.

### DETAILED DESCRIPTION OF THE INVENTION

Embodiments of the present invention will be described in detail as a device for forming a desired mixture of two or more fluids in the context of a chromatographic instrument. Those skilled in the art will recognize that embodiments of the present invention have utility beyond chromatographic processes and instruments and this description should therefore not be limiting.

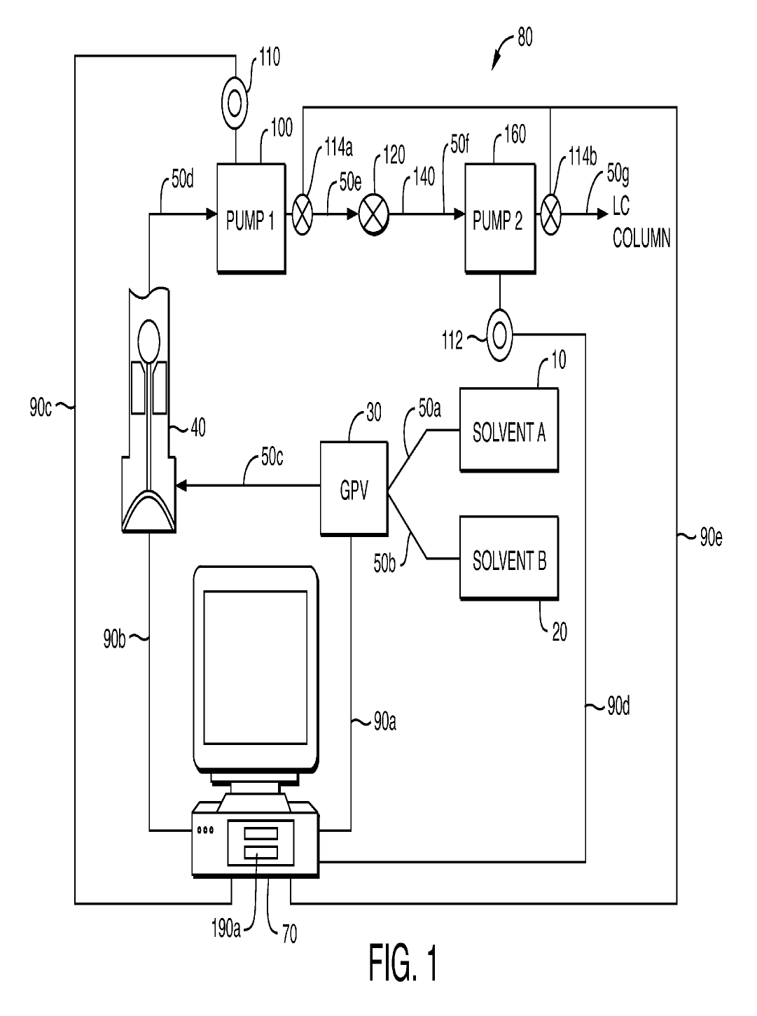

Turning now to FIG. 1, a device, a chromatographic instrument, generally designated by the numeral 80, is depicted. Chromatographic instrument 80 is a substantially closed fluidic system for use in HPLC, gas or critical, near critical or supercritical chromatography. The system is operable at pressures of 500 psi to well over 15,000 psi. Embodiments of the present invention have particular application at high pressures, above 5,000 or 6,000 psi in small conduits.

Embodiments of the present invention address deviations, or errors, in mixing two or more fluids in a conduit from a desired mixture. As used herein, the term “conduit” is used broadly in the sense of a closed fluid system which may comprise tubing, pipes, capillaries, and ancillary apparatus, including, but not limited to, pumps, valves, transducers, filters, mixers, detectors, and columns.

Chromatographic instrument 80 is comprised of the major elements: first fluid source 10, second fluid source 20, a selectable valve 30, a first downstream valve 40, a second downstream valve 120, a first pump 100, a second pump 160, pipes 50a-g, control means 70, signal communication means 90a-e, and pressure transducers 114a and 114b. Chromatographic instruments having these, or similar, major elements are sold by several vendors. For example, chromatographic separation modules are sold by Waters Corporation (Milford, Mass.) under the trademarks ALLIANCE® and ACQUITY® which have many of these elements.

Control means 70 is a computer, such as, without limitation, an integrally wired computational processing unit (CPU) with supporting electronics such as motherboards, displays, memory devices and the like, within the instrument housing [not shown] or, as depicted a personal type computer standing free of other instrument elements, or a server [not shown] located near or distal to the other instrument elements. Computers, CPUs, supporting electronics, servers and the like are well known in the art and are available from numerous vendors. Signal communication means is used to denote any means for sending or receiving data or commands including electric wires, as depicted 90a-e, optical fibers, infrared wireless communication, radio communication, such as, but not limited to, WIFI and cellular communications.

As used herein, the term “signal communication” means capable of receiving and/or transmitting an electronic, optical, infrared or radio or any electromagnetic transmission of data or commands. The term “command” or “commands” means to instruct a device or thing to do something.

The chromatographic instrument 80 forms a desired mixture of two or more fluids in a conduit, which is preferably end pipe 50g. The desired mixture is a combination of the two fluids from first source 10 and second source 20. Chromatographic instrument 80 can draw upon a single source, either first source 10 or second source 20, or a combination of first source 10 and second source 20, and maintain such mixture or single source for a single separation in isocratic operation. In gradient operation, chromatographic instrument 80 will change the mixture drawing different proportions of first fluid and second fluid over time.

Selectable valve 30 is in fluid communication with a source of a first fluid 10 and a source of at least one second fluid 20 via piping 50a and 50b. Selectable valve 30 may be in fluid communication with more than one second fluid. Four fluids are common. However, this discussion, for purposes of clarity and simplicity, will focus on two fluids and two fluid sources. The fluids held in the first fluid source 10 and the second fluid source 20 may themselves be a mixture which will be brought together. As used herein, the term “fluid communication” means plumbed together.

Selectable valve 30 is available from numerous vendors including Waters Corporation (Milford, Mass.) and Jasco Corporation (Hachigi, Tokyo, Japan). The selectable valve 30 is also known as a gradient proportioning valve or GPV. Selectable valve 30 is in signal communication with control means 70 via signal communication means 90a to receive a plurality of first command signals and a plurality of second command signals.

Selectable valve 30 is depicted as a single valve plumbed to first source 10 and second source 20. However, selectable valve 30 may comprise a plurality of valves [not shown] and be plumbed to a T or manifold to place the point in which the first fluid meets the second fluid as close as possible to the pump 100.

Each first command signal directs the selectable valve to produce a first fluid slice, and each second command signal directs the selectable valve to produce a second fluid slice. These first fluid slices and second fluid slices are combined in the piping 50c downstream of selectable valve 30 to create a flow of first fluid slices and second fluid slices. The control means, in response to a desired mixture order, issues a packet-group of first slice command signals and second slice command signals to the selectable valve 30. The selectable valve 30 receives the packet-group of command signals and makes corresponding fluid slices of the first fluid and/or the second fluid to form a mixture-packet of one or more first fluid and second fluid slices. The mixture-packet is one or more first fluid and second fluid slices that correspond to the desired mixture. Whereas the packet-group comprises the group of command signals, the mixture-packet is the corresponding slices of first fluid and second fluid formed by the selectable valve 30. The individual slices of the mixture packet merge through diffusion and mixing as they pass through piping 50a-g, valves 40 and 120, and pumps 100 and 160 to form the desired mixture.

This description will use the notation of a capital letter “A” to represent a slice of a first fluid and a capital letter “B” to represent a slice of a second fluid. A straight line “|” represents a packet boundary. For example, the control means 70 will send to the selectable valve 30 the packet-group of command signals, |AB| for the mixture comprising the desired mixture of one part first fluid and one part second fluid which is expressed by the selectable valve 30 as a slice of first fluid and a slice of second fluid. These slices may have different volumes depending on the time period in which the slice is made. As used in the notation, a small letter “a” or “b” refers to the selectable valve being in an open position during an event. A bracket “[” or “]” is used to denote a bundle of slices or packet boundary received by a chamber of a pump. For example, the notation, [AB|AB]a[AB|AB], refers to two bundles received by a chamber of a pump, in which each bundle is formed of two packets and each packet is comprised of a slice of A and a slice of B. The first bracket “[” denotes the beginning of an intake stroke. The second bracket “]” denotes the end of an intake stroke. The pump chamber after completion of the first intake stroke is filled with the selectable valve open to A, as denoted by the lower case “a”.

Selectable valve 30 is in fluid communication with downstream valve 40 via piping 50c. As depicted, downstream valve 40 is a high pressure valve such as a check valve, either a passive check valve or an active check valve. As depicted in FIG. 1, valve 40 is an active check valve, in signal communication with control means 70 via signal communication means 90b. In response to an open signal from control means 70, the valve 40 will assume an open position. In the open position, fluid from the selectable valve 30 is pulled forward in coordination with pump 100. Valve 40 is available from numerous vendors such as Waters Corporation (Milford, Mass.) and IDEX (Oak Harbor, Wash.).

Valve 40 is in fluid communication with first pump 100 via piping 50d. First pump 100 comprises a first pump chamber and first piston [not shown] of a syringe type known in the art. The first piston is mechanically linked to a first motor 110 which is under signal command with the control means 70 via signal communication means 90c. First pump 100 is in fluid communication with second valve 120 via piping 50e. Second valve 120 is a check valve, either passive or active. As depicted, second valve 120 is passive. Second valve 120 is available from numerous vendors such as Waters Corporation (Milford, Mass.)

Second valve 120 is in fluid communication with a second pump 160 via piping 50f. Second pump 160 comprises a second pump chamber and second piston [not shown] of a syringe type known in the art. The second piston is mechanically linked to a second motor 112 which is under signal command with the control means 70 via signal communication means 90d.

The first pump 100 and second pump 160 are arranged in series; however, embodiments of the present invention have application for single pump systems and parallel pump systems. Second pump 160 is in fluid communication with a column [not shown] known in the art and which column is in fluid communication with a detector [not shown] known in the art.

An error event is an event which causes a deviation from the desired mixture, for example the movement of mixture-packets from an area of low pressure to an area of alternating low and high pressure, or from an area of alternating low and high pressure to an area of high pressure in the conduit. These areas are defined in chromatographic instruments by certain common components as depicted in FIG. 1. Low pressure areas commonly comprise the fluid circuit from first fluid source 10 and/or second fluid source 20, through the selectable valve 30 and up to first downstream valve 40. The area of alternating low and high pressure is normally the fluid circuit from first valve 40 through the first pump chamber under the influence of a reciprocating first piston of pump 100 and up to second valve 120. The high pressure area is the area downstream from second downstream valve 120 including second pump chamber of second pump 160. The movement of bundles into these areas is controlled by the first piston of pump 100 under the control of motor 110.

Another example of an error event is a mechanical event. For example, without limitation, one mechanical event is response time for a valve, either a high pressure valve such as valve 40 and 120 or the selectable valve 30. For example, check valves of the passive type may have seating and release delays due to fluid viscosity or mechanical stickiness of balls to the ball seating areas of the valve.

Another example of a mechanical event is the expansion and contraction of one or more components of the conduit. Expansion and contraction is associated with pump chambers and pistons, adiabatic effects, and valve operation. Check valves of the active type may have seating and release issues like the passive valve and may also have components and parts which expand or contract the conduit or fluid circuit during operation, for example, diaphragms, plungers or valve stems which move during the operation of the valve.

For example, one type of active check valve 40 is sold under the trademark i² Valve™ (Waters Corporation, Milford, Mass.) has a plunger and diaphragm which expand and contract the fluid space in which it operates. As depicted, valve 40 has a plunger and/or diaphragm that displaces about 2.0 to 2.5 microliters. The diaphragm and/or seals [not shown] and/or gaskets [not shown] associated with valve 40 are compliant and under the influence of pressure expand and contract by 0.1 to 0.4 microliters. In a substantially closed system, such as chromatography instrument 80, the expansion and contraction of the fluid space and the displacement and withdrawal of volume caused by plunger and/or diaphragm movement or compliance effects causes movement of fluids through the entry openings at the first fluid source 10 if the selectable valve is open to such source or the entry openings at the second source 20 if the selectable valve is open to such source. The fluid may be displaced in a backward direction or forward direction. If the selectable valve changes from one fluid source to another fluid source, fluid may backup into a piping 50a or 50b from which it did not originate from. The selectable valve 30 may not place the correct slice of fluid, or the subsequent slice fluid may not have the composition intended. Compositional errors of up 5% can occur if the selectable valve 30 is moving from one fluid source to another fluid source during the period in which the first valve 40 is transitioning from one position to another.

A further source of compositional error may occur as the mixture of a packet approaches the limits of a selectable valve 30 to dispense or discharge a slice into a fluid stream. For example, the limit of selectable valve 30 to form a mixture may occur where a slice of a single fluid or small number of slices of a single fluid comprise the total content of such fluid in a packet. Mechanical errors, timing errors, adiabatic effects and compressibility effects will effect a small single slice of a single fluid as a percentage as to the total mixture composition.

The control means 70 has error monitoring means, which identifies error events. An error event is a circumstance or event which would potentially cause a deviation of the mixture composition from the intended desired composition. Error monitoring means comprise programming which identifies any of the command signal or signals for the valve 40 to assume one of the positions of being open or closed, the command signals to the selectable valve 30, the command signals to the motor means 110 of first pump 100, the command signals to motor means 112 of second pump 160, any sensor signals such as positions of the first piston and or the second piston [not shown], and pressure sensors in any of the piping 50a-50g. As depicted pressure sensors, 114a and 114b are in piping 50e and 50g respectively. For example, one error event is the start of an intake stroke of first pump 100.

This error event can be recognized by control means through identification and recognition of such signal commands to the motor means 110 to begin an intake stroke, with respect to direction, velocity and activation of the motor. In another aspect of the invention, the error event is recognized by control means 70 as a programmed desired mixture which results in mixtures in which one of the fluids is a small fraction of the total. Another error event is recognized by control means 70 by position sensors on the first piston [not shown] of first pump 100. Position sensors are known in the art and often take the form of stepper motors which are commonly used. This error event can also be recognized by the signal command or commands to valve 40. The error event can be recognized by pressure transducers 114a and 114b which denote a pressure to the control means which indicate a change in piston direction or valve position is about to take place. A further error event is the programmed change in the mixture.

In another aspect of the invention the error event is a composition deviation from expected values detected by a downstream detector [not shown] in fluid communication with the column [noted but not shown]. Columns for gas, liquid and supercritical fluid applications are well known in the art as well as detectors. By way of example, without limitation, one detector, a UV detector may issue signals to control means indicating that a fluid is not achieving a desired composition. This error event is recognized by error monitoring means by programming which compares detector data values signals to desired values. Embodiments of the present invention feature calibration of the apparatus to identify error events and introduce one or more error packet groups. These error packet groups can be carried forward in the normal operation of the apparatus.

In response to error monitoring means identifying an error event in the signal commands or position signals or sensor signals, the control means 70 organizes the packet-group of command signals to form at least one first error packet-group such that the error event occurs during the period of time in which the at least one error packet-group is received by the at least one selectable valve 30. The at least one error packet-group is an order or timing of first command signals and second command signals to minimize deviation from the desired mixture in the flow of mixture-packets forming the actual mixture of two or more fluids in a conduit during the error event. Timing of the command signals may result in the selectable valve 30 being open or closed for a shorter or longer period of time resulting is slices which may be bigger or smaller.

One embodiment of the present invention features a device wherein the error packet-group has at least two or more consecutive fluid slices selected from one source or such fluid slices are of sufficient volume to accommodate movement of fluids associated with the error event. Another embodiment features at least two error packet-groups associated with a single error event to form a first error packet group having a last in series slice, and a second error packet having a first in series slice, wherein the first in series slice and the end of series slice are adjacent and selected from one source. For example, without limitation, the control means 70 identifies the packet organization case 1 below as having an error event.

### Case 1: [AB|AB]a[AB|AB]a[AB|AB]a[AB|AB]a . . . .

The error event is having the piston stroke change with selectable valve 30 effecting a change from second fluid source B to first fluid source A with an open pipe 50a to the first fluid source. This error event is identified by the signal commands being sent to the selectable valve and signal commands being sent to pump 100 or signal commands being sent to downstream valve 40. Control means 70 in response to the error event identified by error monitoring means, issues command signals for at least one error packet group. This error packet group is “|BA|” and would be expressed in the notation as Case 2 set forth below.

### Case 2: [AB|BA]a[AB|BA]a[AB|BA]a[AB|BA]a . . . .

The error event encountered and described in Case 1 is a mechanical type associated with expansion and contraction of first downstream valve 40 due to valve diaphragms and plunger movements and piston movements. This expansion and contraction has an associated expansion and contraction volume. The error packet group comprises consecutive slices of a fluid from a selected source in which the consecutive slices have a consecutive slice volume approximately equal to or greater than the expansion and contraction volume. This error packet group can be programmed into control means as the default packet group structure for mixtures.

Changes in the desired mixture such as in gradient operation create further error events. In gradient operation, control means 70 receives first directions for a first mixture and at least one second direction for a second mixture. The first mixture has a first composition of first fluid and second fluid, and the second mixture has a second composition of first fluid and second fluid, which first fluid composition and second fluid composite are different. The change in composition from a first mixture to a second mixture requires the packets to change. A slice of a fluid which comprises a volume which approaches the limit of the device to accurately measure and release, due to the mechanical features described above, is best positioned in the packet away from the events giving rise to the errors. The transition, from directions for a first mixture to a second mixture, and a slice volume approaching a threshold value, is an error event identified by error monitoring means. For example, in Case 2, in a gradient, the mixture is represented by the packet |AB|, and over time the slice A in each successive packet or groups of packets is made smaller. Each of these changes is a new mixture. As the slice A becomes smaller, the mechanical errors associated with the formation of slices by the device tend to have a greater effect on slice A as a percentage of the volume of such slice. The error monitoring means identifies the error event and control means 70 introduces an error packet and a second represented by the packet |BA| as described in Case 3 below.

Case 3: [AB|BA]a[AB|BA]a[AB|BA]b[BA|AB]b[BA|AB]b . . . .

The transition is the highlighted by a bold and underlined “b” which denotes an open selectable valve 40 to source “B” or the second source 20 as the pump ends and begins a new intake stroke. This too could define an error event; however, the error event represented by the open b and ending slice A is recognized as acceptable by control means 70. In this instance, the error event defined by the end slice A and open b is a singular event and the slice A is small and will be mixed in the conduit. The relatively small slice A is placed away from potential error events at the beginning or end of a intake stroke. The slices A are grouped together in between pairs of B slices where the larger B slices may be subject to extraction and contraction volumes.

However, in the event the open selectable valve to source B is not acceptable, a further correction is implemented by control means 70. The control means introduces a further error packet |AB| replacing the packet |BA| immediately before the open selectable valve event “b”. This is further described as Case 4 below.

Case 4: [AB|BA]a[AB|BA]a[AB|AB]b[BA|AB]b[BA″AB]b . . . .

A preferred threshold value is ten percent, that is, where a slice volume is ten percent of the total volume of the packet. In the example above A, from the first fluid source 10, is becoming a smaller percentage of the total packet composition. Case 4 sets forth a packet arrangement for A becoming nil. If the gradient continues to a single fluid B, from the second source 20, the packets can shift to |BB|.

In the alternative, in the Case 2 scenario above where slice A approaches or reaches a threshold value, a small value, in which deviations in the amount of slice A, particularly if repeated through several packet cycles will result in substantial error in the mixture composition, is to alter the timing of the first commands and second commands to create a larger period in which slice A is placed in the pipe 50c in a first slice A event (A1) and a correspondingly smaller period in which slice A is placed in pipe 50c in a second slice A event (A2). Case 5 describes such error correction packages.

### Case 5: [AB|BA]a[AB|BA]a[A1B|BA2]a[A1B|BA2]a

In Case 5, the underlined packet-groups are error packets. The first in time error packet is denoted with the slice A1. Slice A1 is of longer duration creating a larger slice and slice A2, second in time a smaller slice.

The error packets groups issued by control means 70 allow highly specific and accurate composition mixtures in gradients from 0% to 100% of a solution. Embodiments of the present invention allow the composition of the mixture in pipe 50g to be within 0.5% of the desired mixture.

For purposes of simplicity, clarity and understanding, the discussion and the drawing present two sources of fluid, first source 10 and second source 20. Those skilled in the art will readily recognize that this discussion serves equally well with more than two fluid sources. A plurality of fluid sources greater than two is not unusual, indeed, four fluid sources are common.

Chromatography instruments, such as instrument 80, are capable of operation with different stroke lengths. Preferably, the control means 70 sizes packets and commands the pump to assume one of the piston positions as the packet groups for the first mixture end and the packet groups for a second mixture begin.

The discussion features bundles of packets with two packets corresponding to the volume of the piston chamber [not shown] of pump 100. The number of packets which can be formed and placed in a piston chamber at one time is a function of convenience and choice limited only by the speed of the selectable valve and the velocity of the piston [not shown] pumping fluids. For example, a bundle, referring to the number of packets filling a chamber, may comprise one packet to a large number of packets.

Control means 70 is programmed with operating instructions to form packets and has error monitoring means to identify error events. Those skilled in the art of computer programming have the necessary skills to program control means 70 of chromatographic instruments 80 with operating instructions with the guidance of the present disclosure. Where the error event is known or well characterized, control means 70 is preprogrammed to avoid the error event or solve the error event with a responsive programmed error packet group.

One expression of a program is set forth below in which the control means is programmed with operating instructions to group smaller slices away from error events as a gradient is performed.
Start with 2 packets per stroke: [AB|AB]b
Sort first packet A,B in this stroke by their slices big to small to get AB, here A>B.
Make BA (mirror the first packet) order for second packet in this stroke:
   Make this stroke [AB|BA]a
When A<minimum, make a transition stroke. The first packet for this transition stroke is AB and the second packet for this stroke is AB
Make transition packets [AB|AB]
Go back to Sort step.

This expression may take many forms. The expression features two fluids; other embodiments may include more than two fluids with four being common.

One embodiment of the present invention is directed to a computer storage device [not shown] for providing operating instructions to control means 70 in signal communication with or part of a fluid conveying device, such as chromatographic instrument 80, for forming a desired mixture of two or more fluids in a conduit or pipe 50g. The computer storage device of the present invention refers to memory for storing computer programs such as, by way of example, without limitation, computer storage disks, tapes, flash drives, hard drives, CDs, DVDs, memory sticks, and chips, whether integral to the computer or external. Computer storage devices are well known in the art. A computer storage device is represented in FIG. 1 as one of the slots 190 for receiving a DVD or CD. The fluid conveying device has at least one selectable valve 30 in fluid communication with a source of a first fluid 10 and a source of at least one second fluid 20. The selectable valve 30 is in signal communication with control means 70 to receive a plurality of first command signals and a plurality of second command signals. Each first command signal is to produce a first fluid slice, and each second command signal is to produce a second fluid slice, to create a flow of first fluid slices and second fluid slices in the conduit. The fluid conveying device 80 further comprises control means 70 with error monitoring means. The control means 70 is in signal communication with the selectable valve 30. The error monitoring means detects an error event.

The operating instructions instruct control means 70, in response to a desired mixture order, to issue a packet-group of first command signals and second command signals to the selectable valve 30 to form a mixture-packet of one or more first fluid and second fluid slices in which the mixture-packet of one or more first fluid and said second slices corresponds to the desired mixture. The control means 70, in response to an error event from error monitoring means, organizes the packet-group of command signals to form at least one first error packet group such that error event occurs during the period of time in which the at least one error packet-group is received by the at least one selectable valve 30. The at least one error packet-group comprises an order or timing of first command signals and second command signals to minimize deviation from the desired mixture in the flow of mixture-packets forming the desired mixture of two or more fluids in a conduit during the error event.

Embodiments of the present invention directed to a method of forming a desired mixture in a conduit, are exemplified in the operation of the chromatography instrument 80. The method comprises the step of providing a conduit, such as pipes 50a-50g, having at least one selectable valve 30 in fluid communication with a source of a first fluid 10 and a source of at least one second fluid 20. The selectable valve 30 is in signal communication with control means 70 to receive a plurality of first command signals and a plurality of second command signals. Each first command signal produces a first fluid slice, and each second command signal produces a second fluid slice, to create a flow of first fluid slices and second fluid slices in the conduit, pipes 50a-50g. The method further comprises the step of providing control means 70 in signal communication with the selectable valve 30. The control means 70, in response, to a desired mixture order, issues a packet-group of first command signals and second command signals to the selectable valve 30 to form a mixture-packet of one or more first fluid and second fluid slices. The mixture-packet of one or more first fluid and said second fluid slices corresponds to the desired mixture. The control means 70 has error monitoring means and in response to an error event the control means 70 organizes the packet-group of command signals to form at least one first error packet group such that error event occurs during the period of time in which the at least one error packet-group is received by the at least one selectable valve 30. The at least one error packet-group comprising an order or timing of first command signals and second command signals to minimize deviation from said desired mixture in the flow of mixture-packets forming the desired mixture of two or more fluids in a conduit during the error event. The method further comprises the step of providing a desired mixture order to the control means 70 and operating the control means 70 to produce the desired mixture in the conduit, piping 50a-50g.

Embodiments of the method of the present invention have features that are analogous to those previously described with respect to the device.

Thus, we have described the present invention with respect to the best mode and the manner of making and using it with the understanding that the described embodiments are capable of being modified and altered without departing from the present teaching. Therefore, the present invention should not be limited to the precise details described herein but should encompass the claimed subject matter and its equivalents.

We claim:

1. A device for forming a desired mixture of two or more fluids in a conduit comprising:
at least one selectable valve in fluid communication with a source of a first fluid and a source of at least one second fluid, said selectable valve in signal communication with control means to receive a plurality of first command signals and a plurality of second command signals, each first command signal to produce a first fluid slice, and each second command signal to produce a second fluid slice, to create a flow of first fluid slices and second fluid slices in said conduit; and,
control means in signal communication with said selectable valve means, said control means in response to a desired mixture order issuing a packet-group of first command signals and second command signals to said selectable valve to form a mixture-packet of one or more first fluid and second fluid slices in which said mixture-packet of one or more first fluid and said second fluid slices corresponds to said desired mixture, said control means having error monitoring means and in response to an error event said control means organizing said packet-group of command signals to form at least one first error packet group such that error event occurs during the period of time in which said at least one error packet-group is received by said at least one selectable valve, said at least one error packet-group comprising an order or timing of first command signals and second command signals to minimize deviation from said desired mixture in said flow of mixture-packets forming said desired mixture of two or more fluids in a conduit during said error event.

2. The device of claim 1 wherein said at least one error packet-group has at least two or more consecutive fluid slices selected from one source.

3. The device of claim 2 further comprising at least two error packet-groups associated with a single error event to form a first error packet group having a last in series slice, and a second error packet having a first in series slice, wherein said first in series slice and said end of series slice are selected from one source.

4. The device of claim 1 wherein said error event is the movement of a bundle of packets moving from an area of low pressure to an area of alternating low and high pressure in said conduit.

5. The device of claim 4 wherein said area of alternating low and high pressure is a pump chamber.

6. The device of claim 1 wherein said error event is a mechanical event.

7. The device of claim 6 wherein said mechanical event is response time for a valve.

8. The device of claim 6 wherein said mechanical event is expansion and contraction of one or more components of the conduit.

9. The device of claim 8 wherein said expansion and contraction of one or more components of the conduit is associated with a diaphragm.

10. The device of claim 8 wherein said expansion and contraction is associated with an expansion and contraction volume.

11. The device of claim 10 wherein said error packet group comprises consecutive slices of a fluid from a selected source said consecutive slices having a consecutive slice volume approximately equal to said expansion and contraction volume.

12. The device of claim 6 wherein said mechanical event is associated with a seating error associated with a valve.

13. The device of claim 1 wherein said conduit means further comprises at least one downstream valve, said at least one downstream valve receiving mixture packets from said selectable valve, said downstream valve having two operable positions comprising an open position in which mixture packets flow through said conduit and a closed position in which said mixture packets do not flow.

14. The device of claim 13 wherein said error event is associated with said downstream valve one of said operable positions.

15. The device of claim 14 wherein said downstream valve is in signal communication with control means to receive one or more downstream valve command signals, said downstream valve upon receiving said downstream command signal assuming one of said operable positions.

16. The device of claim 15 wherein said downstream valve command signal is an error monitoring means.

17. The device of claim 1 wherein said device further comprises a pump having at least one chamber defining an area of alternating high and low pressure, and a piston for assuming at least one piston first position wherein said chamber has a high pressure and at least one piston second position in which said chamber has a low pressure, said error event associated with said pump assuming at least one of said piston positions.

18. The device of claim 17 wherein said device further comprises motor means mechanically linked to said piston to compel said piston to assume one of said piston positions.

19. The device of claim 18 wherein said motor means is in signal communication with said control means and receives motor command signals to assume one of said piston positions.

20. The device of claim 19 wherein said motor command signal is an error monitoring means.

21. The device of claim 1 wherein said control means receives directions for a first mixture and a second mixture, said first mixture having a first composition of first fluid and second fluid and said second mixture having a second composition of first fluid and second fluid which first fluid composition and second fluid composite are different, said transition from directions for a first mixture to a second mixture comprising an error monitoring means.

22. The device of claim 21 wherein said control means commands said pump means to assume one of said piston positions as said packet groups for said first mixture end and said packet groups for said second mixture begin.

23. The device of claim 1 wherein said error event is associated with an error volume.

24. The device of claim 23 wherein said at least one error packet group has consecutive slices selected from a source having a slice volume approximately equal to said error volume.

25. A method of forming a desired mixture in a conduit, comprising the steps of:
providing a conduit having at least one selectable valve in fluid communication with a source of a first fluid and a source of at least one second fluid, said selectable valve in signal communication with control means to receive a plurality of first command signals and a plurality of second command signals, each first command signal to produce a first fluid slice, and each second command signal to produce a second fluid slice, to create a flow of first fluid slices and second fluid slices in said conduit; and,
providing control means in signal communication with said selectable valve, said control means in response to a desired mixture order issuing a packet-group of first command signals and second command signals to said selectable valve to form a mixture-packet of one or more first fluid and second fluid slices in which said mixture-packet of one or more first fluid and said second fluid slices corresponds to said desired mixture, said control means having error monitoring means and in response to an error event said control means organizing said packet-group of command signals to form at least one first error packet group such that error event occurs during the period of time in which said at least one error packet-group is received by said at least one selectable valve, said at least one error packet-group comprising an order of first command signals and second command signals to minimize deviation from said desired mixture in said flow of mixture-packets forming said desired mixture of two or more fluids in a conduit during said error event;
providing a desired mixture order to said control means and operating said control means to produce said desired mixture in said conduit.

26. The method of claim 25 wherein said at least one error packet-group has at least two or more consecutive fluid slices selected from one source.

27. The method of claim 26 further comprising at least two error packet-groups associated with a single error event to form a first error packet group having a last in series slice, and a second error packet having a first in series slice, wherein said first in series slice and said end of series slice are selected from one source.

28. The method of claim 25 wherein said error event is the movement of a bundle of packets moving from an area of low pressure to an area of alternating low and high pressure in said conduit.

29. The method of claim 26 wherein said area of alternating low and high pressure is a pump chamber.

30. The method of claim 25 wherein said error event is a mechanical event.

31. The method of claim 30 wherein said mechanical event is response time for a valve.

32. The method of claim 30 wherein said mechanical event is expansion and contraction of one or more components of the conduit.

33. The method of claim 30 wherein said expansion and contraction of one or more components of the conduit is associated with a diaphragm.

34. The method of claim 30 wherein said expansion and contraction is associated with an expansion and contraction volume.

35. The method of claim 34 wherein said error packet group comprises consecutive slices of a fluid from a selected source said consecutive slices having a consecutive slice volume approximately equal to said expansion and contraction volume.

36. The method of claim 30 wherein said mechanical event is associated with a seating error associated with a valve.

37. The method of claim 25 wherein said conduit means further comprises at least one downstream valve, said at least one downstream valve receiving mixture packets from said selectable valve, said downstream valve having two operable positions comprising an open position in which mixture packets flow through said conduit and a closed position in which said mixture packets do not flow.

38. The method of claim 37 wherein said error event is associated with said downstream valve assuming one of said operable positions.

39. The method of claim 38 wherein said downstream valve is in signal communication with control means to receive one or more downstream valve command signals, said downstream valve upon receiving said downstream command signal assuming one of said operable positions.

40. The method of claim 39 wherein said downstream valve command signal is an error monitoring means.

41. The method of claim 25 wherein said device further comprises a pump having at least one chamber defining an area of alternating high and low pressure, and a piston for assuming at least one piston first position wherein said chamber has a high pressure and at least one piston second position in which said chamber has a low pressure, said error event associated with said pump assuming at least one of said piston positions.

42. The method of claim 41 wherein said device further comprises motor means mechanically linked to said piston to compel said piston to assume one of said piston positions.

43. The method of claim 42 wherein said motor means is in signal communication with said control means and receives motor command signals to assume one of said piston positions.

44. The method of claim 43 wherein said motor command signal is an error monitoring means.

45. The method of claim 25 wherein said control means receives directions for a first mixture and a second mixture, said first mixture having a first composition of first fluid and second fluid and said second mixture having a second composition of first fluid and second fluid which first fluid composition and second fluid composite are different, said transition from directions for a first mixture to a second mixture comprising an error monitoring means; said method further comprising the step of ordering control means to form a first mixture and a second mixture.

46. The method of claim 45 wherein said control means commands said pump means to assume one of said piston positions as said packet groups for said first mixture end and said packet groups for said second mixture begin.

47. The method of claim 25 wherein said error event is associated with an error volume.

48. The method of claim 47 wherein said at least one error packet group has consecutive slices selected from a source having a slice volume approximately equal to said error volume.

49. As an article of manufacture, a computer storage device for providing operating instructions to control means of a fluid conveying device for forming a desired mixture of two or more fluids in a conduit having at least one selectable valve in fluid communication with a source of a first fluid and a source of at least one second fluid, said selectable valve in signal communication with control means to receive a plurality of first command signals and a plurality of second command signals, each first command signal to produce a first fluid slice, and each second command signal to produce a second fluid slice, to create a flow of first fluid slices and second fluid slices in said conduit; and, control means having error monitoring means and in signal communication with said selectable valve,
said operating instructions instructing control means, in response to a desired mixture order, to issue a packet-group of first command signals and second command signals to said selectable valve to form a mixture-packet of one or more first fluid and second fluid slices in which said mixture-packet of one or more first fluid and said second fluid slices corresponds to said desired mixture, said error monitoring means identifying error events and in response to an error event said control means organizing said packet-group of command signals to form at least one first error packet group such that error event occurs during the period of time in which said at least one error packet-group is received by said at least one selectable valve, said at least one error packet-group comprising an order of first command signals and second command signals to minimize deviation from said desired mixture in said flow of mixture-packets forming said desired mixture of two or more fluids in a conduit during said error event.
